(19) United States
(12) Patent Application Publication
(10) Pub. No.: US 2007/0219829 A1
(43) Pub. Date: Sep. 20, 2007

(54) Medical record association for disability determinations

(76) Inventor: Lay K. Kay, Pasadena, CA (US)

Correspondence Address: MCDERMOTT WILL & EMERY LLP, 18191 VON KARMAN AVE., SUITE 500, IRVINE, CA, 92612-7108, US

(21) Appl. No.: 11/378,154

(22) Filed: Mar. 17, 2006

(51) Int. Cl. G06F 17/30; G06F 19/00

(52) U.S. Cl. 705/3; 707/3; 707/9

(57) ABSTRACT

An electronic medical record system and method are disclosed, the system comprising a medical query generated based on a medical or disability rules collection and based on an individual's medical or disability claim; an electronic medical record containing data responsive to said query; a viewing module for displaying at least a portion of said medical query and portion of said electronic medical record; and a linking module for linking at least a portion of said medical query to at least one section of said responsive data in said electronic medical record. In certain embodiments, the electronic medical record system further comprises a retrieval module configured for retrieving said linked responsive data in said electronic medical record to said linked query in response to a retrieval request by a user of the viewer. In other embodiments, the system further comprises a highlighting module configured to highlight the at least one section of said responsive data in said electronic medical record.

### BACKGROUND OF THE INVENTION

1. Field of the Invention

The invention relates generally to the display of electronic documents and more particularly to the viewing of electronic medical records.

2. Description of the Related Art

Patients often receive health care from a number of different health care practitioners in a multitude of settings. In a single year, a patient may receive care in several clinics. This care may be provided by many people, such as a family practitioner, dentist, and a pharmacist. The medical record for such a patient may thus be divided amongst several different locations, which may be in paper format in some locations and in electronic format in other locations. Consequently, it would be difficult to obtain the entire medical record of a patient at one time.

Electronic medical records (“EMR”) allow for the storage of some or all of a patient's medical record in one convenient electronic record, such that a patient's entire medical record may be accessed at one time. EMRs facilitate, among many things, access of clinical data by staff at any location, making clinical notes, prescribing medications, sending information to labs. EMRs also facilitate claims processing by insurance companies.

Standard medical records and electronic medical records are very important in the disability industry. For example, when a patient (claimant) applies for disability status, the prior medical record of the claimant must be gathered to either support or reject the claim. Due to the special nature of the disability claim, the process of gathering and organizing the medical evidence used to create the medical record is very challenging. If the claimant's record is not already in an EMR format, the medical evidence may need to be collected from a multitude of sources, including both long-term and short-term records. Afterwards, the claimant's medical record, whether an EMR or not, must be organized for review by a rating specialist to review and extract relevant disability information and match it against specific queries to rate the claim. In the medical treatment environment, a healthcare practitioner must likewise review a patient's medical record in order to extract relevant information in order to determine how to best treat a patient.

Healthcare practitioners must often spend unnecessary time flipping through records in multiple different files on a patient or scrolling though dozens of pages of an EMR on a patient in order to find relevant information in that patient's medical record. A healthcare practitioner's training often goes to waste searching through records when a less trained assistant, such as a nurse or clerk, might be able to locate certain items in a medical record. The time a healthcare practitioner spends searching through a record may be better spent by making use of the practitioner's training, such as by treating patients.

In the disability industry, a rating specialist similarly wastes significant time searching through a claimant's medical record in response to questions or guidelines presented to rate a claim. The average thickness of a claim file is two to three inches; the size of the corresponding EMR is similarly lengthy. As the claim file gets larger, organizing the information becomes more difficult, making the job of the rating specialist more difficult because the specialist is responsible for matching the relevant information from the claim file to the disability rating queries.

### SUMMARY OF THE INVENTION

Thus, it would be advantageous to develop a method and system for reducing the time spent by healthcare practitioners and other specialists to search through a medical record for relevant information.

One embodiment discussed herein discloses a system where a part of an EMR is shown along with at least one medical query. A medical query is advantageously linked to portions of the EMR relevant to the query. In certain embodiments, the EMR sections that are linked are advantageously highlighted to inform a user that the medical record data is linked to a relevant query. The system may also contain features organizing sections of the EMR or medical queries, such as a list of patients or claimants whose data is stored in the system, a table of contents, and an index. In order to increase security and to only allow authorized access to data stored in the system, the system may also feature login or password protection.

Neither this summary nor the following detailed description purports to define the invention. The invention is defined by the claims. For purposes of summarizing the invention, certain aspects, advantages and novel features of the invention have been described herein. It is to be understood that not necessarily all such advantages may be achieved in accordance with any particular embodiment of the invention. Thus, the invention may be embodied or carried out in a manner that achieves or optimizes one advantage or group of advantages as taught herein without necessarily achieving other advantages as may be taught or suggested herein.

### BRIEF DESCRIPTION OF THE DRAWINGS

Systems and methods which embody the various features of the invention will now be described with reference to the following drawings, in which:

FIG. 1 is a sample screen from a particular embodiment of the electronic medical record system for disability claims showing highlighting and linking features.

FIG. 2 is a sample flow diagram of how a medical query may be linked to a portion of the EMR.

FIG. 3 is a sample screen from a particular embodiment of the electronic medical record system for disability claims showing an index feature.

FIG. 4 is a sample screen from a particular embodiment of the electronic medical record system showing a table of contents feature.

FIG. 5 is a sample screen from a particular embodiment of the electronic medical record system showing a sample login screen to protect access to medical record data.

FIG. 6 shows a sample digital computer system for use with the electronic medical record system

### DETAILED DESCRIPTION OF THE PREFERRED EMBODIMENT

In the following description, reference is made to the accompanying drawings, which form a part hereof, and which show, by way of illustration, specific embodiments or processes in which the invention may be practiced. Where possible, the same reference numbers are used throughout the drawings to refer to the same or like components. In some instances, numerous specific details are set forth in order to provide a thorough understanding of the present disclosure. The present disclosure, however, may be practiced without the specific details or with certain alternative equivalent components and methods to those described herein. In other instances, well-known components and methods have not been described in detail so as not to unnecessarily obscure aspects of the present disclosure.

Certain embodiments discussed herein disclose a system for reducing the time spent by healthcare practitioners and other specialists to search through a medical record for relevant information. In one embodiment, a portion of an EMR is displayed along with certain medical queries. A medical query may then be advantageously linked to a related section or sections of the EMR. The existence of the link may be identified by highlighting either the query, the relevant portion of the EMR, or both. In other embodiments, methods other than highlighting may be used to demarcate a linked portion of either the medical query or EMR. Furthermore, in certain embodiments, sections of the EMR which meet the requirements set by the query may advantageously be highlighted with a first color while other sections of the EMR which do not meet the requirements set by the query may advantageously be highlighted with a second color. By highlighting positive data with one color and negative data with another a color, a user of the embodiment may advantageously reduce the time spent in identifying the existence of either positive or negative data.

As discussed herein, an EMR is an electronic medical record, or computer-based patient medical record. An electronic medical record may include systems which keep track of relevant medical information, an electronic healthcare record (“EHCR”), computerized medical record (“CMR”), electronic patient record (“EPR”), or electronic health record (“EHR”). Furthermore, as discussed herein, a query relating to an individual's medical history may include but are not limited to disability rating criteria, medical evaluation forms, disability or medical rules, disability or medical queries, health questionnaires, or any questions or evaluation rules that may relate to a patient's health.

A portion of a patient's EMR may be considered related or relevant to a medical query if the EMR portion somehow addresses or provides support, whether positive or negative, to the query. For example, if the medical query was a disability evaluation question asking whether or a patient's knee had been examined, then the query may advantageously be linked to an outpatient note in a patient's EMR related to a knee examination.

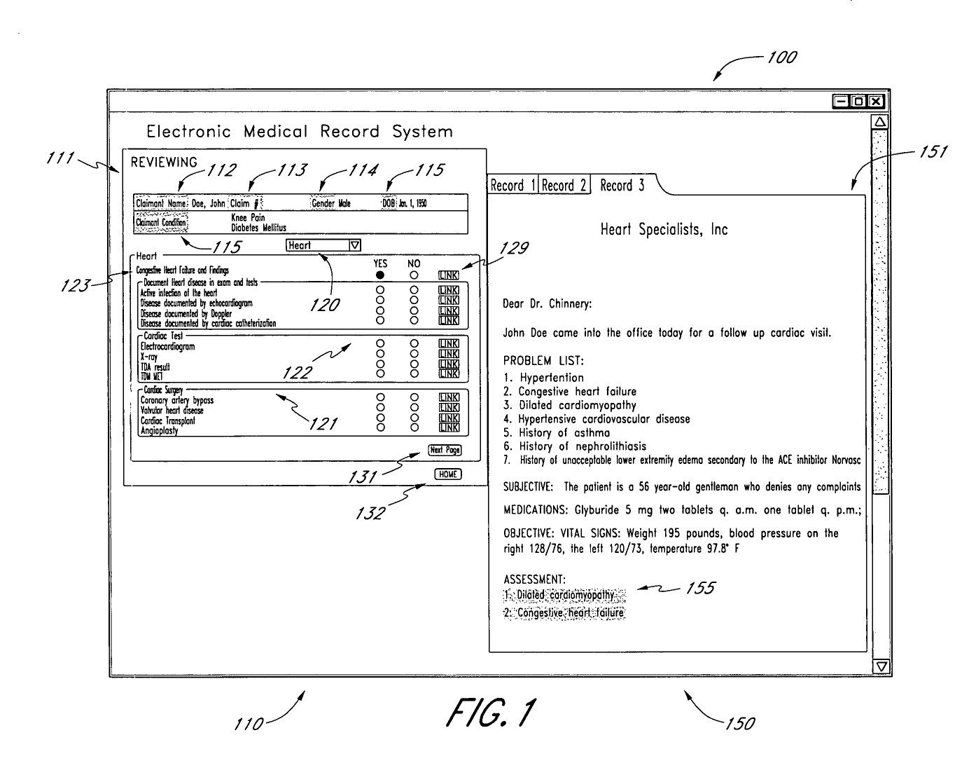

FIG. 1 is a sample screen from a particular embodiment of the electronic medical record system 100 for disability claims showing highlighting and linking features. In certain embodiments, the system disclosed herein advantageously allows a user to create an electronic association (or “link”) between a part of an EMR and a medical query that is stored in computer memory. In certain embodiments, the link may be stored in volatile memory, such as random access memory (“RAM”), and in other embodiments, the link may be stored in non-volatile memory, such as a hard disk drive or flash drive. As used herein, linking refers to an association between a medical query and a portion or section of the EMR. The association allows a user to advantageously view the associated section of the EMR by accessing the association from the associated medical query. The association may take many forms. In certain embodiments, the association is a link between the associated part of the EMR and the associated medical query. By selecting the link coupled with the associated medical query, the user may then view or otherwise access the part of the EMR associated with the medical query.

In certain embodiments of the systems and methods described herein, a part of the display may be allotted for displaying medical queries 111. The medical query portion of the screen (“query display”) 110 may in certain embodiments contain a patient identity area which displays static information related to a patient or claimant, such as their name 112, claim number 113, gender 114, date of birth 115, and claimed conditions 116.

The medical queries may advantageously be organized by medical condition, where relevant portions of a patient's medical history are grouped in the query display 110 according to a symptom, diagnosis, disease, or other category. In yet further embodiments, medical queries may be organized by certain areas of the body. In the sample screen shown, the medical queries are organized by a part of the body, specifically, the heart 120.

The query display 110 may include a section with specific medical queries 121 and, in certain embodiments, responses to those queries 122. For example, in the sample screen shown, one medical query relates to whether there are findings related to congestive heart failure 123. The response in the sample figure is “yes” 123. In other embodiments, the query display may not contain responses to the query, but instead link to the relevant portion of the EMR. A user may then view the relevant portion of the EMR related to the medical query, for example, by pressing the “link” button 124. In the sample screen, the heart failure data 155 in the EMR 151 is highlighted and linked to the congestive heart failure finding query 123 in the medical queries 111. The query display may also contain a “home” button 132 which when selected takes the user to a home page, such as an index page or table of contents page.

In certain embodiments of the systems and methods described herein, a part of the display may be allotted for displaying a patient's EMR (“EMR display”) 150. In certain embodiments, portions of the EMR which are selected to be linked to medical queries may appear highlighted 155, as shown in FIG. 1. In other embodiments, other methods may be used, such as underlining or bolding. In yet further embodiments, portions of the EMR 151 may not be displayed differently to the user even though they are linked to medical queries 111.

A patient's EMR 151 may advantageously be organized in many different ways. In certain embodiments, an EMR 151 may be organized in chronological order, such that a patient's medical history is presented to the user in a format corresponding to when the medical events occurred. In other embodiments, the EMR 151 may be organized by a medical condition, where relevant portions of a patient's medical history are grouped in the EMR 151 according to a symptom, diagnosis, disease, or other category. In yet further embodiments, the EMR 151 may be organized by certain areas of the body. For example, all medical evidence related to the heart may be grouped together in one section of the EMR 151.

The portion of the display configured to display any content herein, such as a patient's EMR 151 or medical queries 111, may take the form of a window, frame, or any other well known display technique known in the art. Furthermore, the display areas 110, 150 may be configured to overlay other content that is being displayed, such as having a portion of the EMR display 150 appear to lie over a portion of the query display 110. Content which may require more than the allotted screen space to be completely displayed may be accessed by any known method in the art, including but not limited to scrolling for additional content or placing content on different pages, pressing a button to go to a following or preceding page 131, or tabs 153, such that by choosing to view a certain page or tab additional content may be viewed.

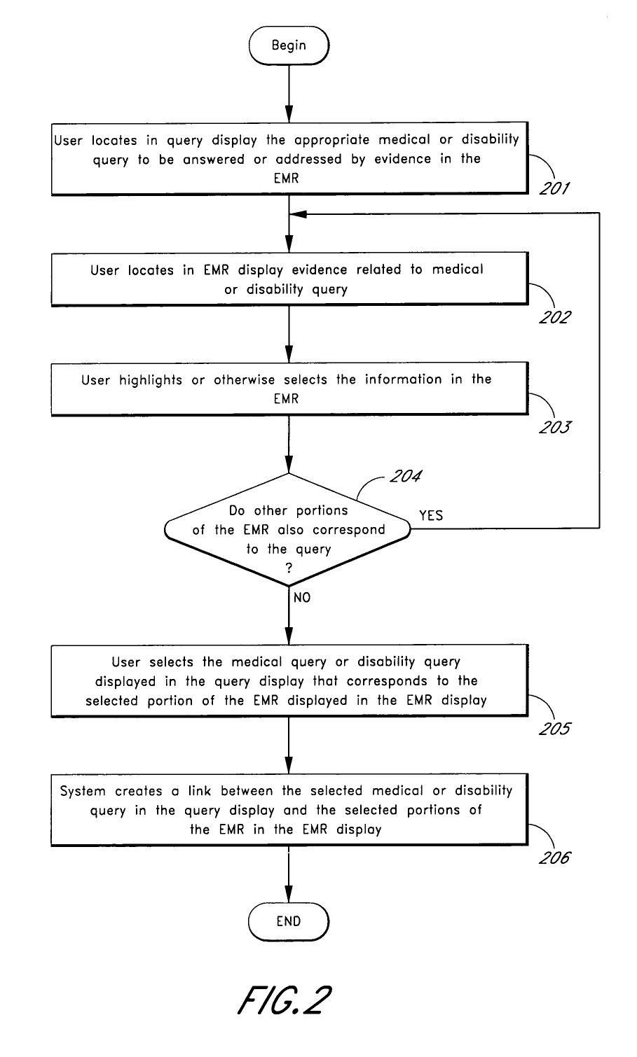

FIG. 2 is a sample flow chart of how to highlight and link a certain portion of the EMR 151 to a certain medical or disability query 111. First, according to step 201, in the query display 110, a user locates the appropriate medical query 121 to be answered or addressed 122 by evidence in the EMR 151. Then, according to step 202, in the EMR display 150, the user searches through the EMR 151 for evidence related to the query 121. Upon finding relevant information related to the query 121 in the EMR display 150 from the EMR 151, in step 203 the user highlights or otherwise selects the information in the EMR 151. Portions of the EMR 151 may be highlighted according to any well known method in the art. In certain embodiments, the user can hold down an interface button, such as a mouse button, and drag the cursor associated with the button across the text selected for highlighting. After the user drags the cursor across all of the relevant text, the user may let go of the mouse button to complete the highlighting of the text. This feature may be advantageously used where portions of the EMR 151 have been converted to machine readable text, as discussed below. In certain embodiments, a user may highlight a portion of the EMR 151 by creating a selection box around the portion of the EMR that is selected to be highlighted. In certain other embodiments, the selected text or area of the EMR 151 may not be highlighted but may instead be linked, as will be discussed. If other portions of the EMR 151 also correspond to the query 121, then according to step 204 the user may similarly select those portions of the EMR 151 in the EMR display 150 by returning to step 202, or otherwise may proceed to step 205 if all relevant portions of the EMR 151 have been selected.

Next, after the user highlights or selects a portion of the EMR 151, in step 205 the user may click on, answer, edit, or otherwise select the portion of the medical query 111 displayed in the query display 110 that corresponds to the selected portion of the EMR 151 displayed in the EMR display 150. In certain other embodiments, the order may be reversed, where a user first selects a medical query 111 before selecting a portion of the EMR 151 in order to link the two. The electronic medical record system 100 in step 206 then creates a link between the medical query 121 in the query display 110 and the selected portions of the EMR 151 in the EMR display 150. The link may be created in many different ways, including, but not limited to: automatically, as soon as the user selects a medical query 111 after selecting a portion of the EMR 151; by prompting the user if a link should be created after the user selects a medical query 111 after selecting a portion of the EMR 151; or manually, by having the user manually choose to create a link between a selected portion of the EMR 151 in the EMR display 150 and a medical query 111 in the query display 110, such as by pressing a create-link button or by clicking and holding on the selected portion of the EMR 151, then dragging the cursor to the relevant portion of the medical query 111.

In certain embodiments discussed herein, a certain portion of the medical query 111 may be advantageously linked to several sections of an EMR 151. Consequently, a plurality of portions of the EMR 151 that are relevant to a medical query 111 may be accessible to a user by accessing only one medical query 111, such as by pressing a link button 124. In certain embodiments where both positive evidence and negative evidence related to a medical query 121 are linked to that medical query 121, then the system may advantageously link to all of both the positive and negative portions of the EMR 151.

In certain embodiments discussed herein, relevant portions of the EMR 151 may be highlighted using different colors. In certain embodiments, portions of the EMR 151 which provide support or are otherwise present positive data in relation to the associated query among the medical queries 111 may be highlighted a certain color, while portions of the EMR 151 which qualify or otherwise present negative data in relation to the associated query among the medical queries 111 may be highlighted a different color. For example, if a medical query 121 for a disability claim requires that a patient have less than 50% knee mobility, and the EMR 151 in one location contains evidence of 30% knee mobility for the patient, then that portion of the EMR 151 may be highlighted green because it supports the medical query 121. Alternatively, if one portion of the EMR 151 contains evidence that the same patient has full mobility in his knee, then that portion of the EMR 151 may be highlighted red because it qualifies the medical query 121.

Medical queries 111 may be advantageously linked to portions of the EMR 151 by users including but not limited to health care practitioners, such as nurses or clerks. Any user who is capable of finding relevant portions of the EMR 151 in response to medical queries 111 may create a link between the EMR 151 and the medical queries 111. By having medical queries 111 advantageously linked to the EMR 151 by a nurse or clerk before the data ever reaches the health care practitioner, the health care practitioner saves valuable time from searching through the EMR 151 and may more adequately dedicate her time to using her specialized training for the patient.

Portions of the EMR 151 may be scanned in and stored according to methods known in the art. It is advantageous to scan in medical records as part of the EMR 151 where the original record was in hard copy format. When certain sections of the EMR 151 contain scanned images, then the system may use optical character recognition (“OCR”) technology or other technology designed to translate images of typewritten text, usually captured by a scanner, into machine-editable text, or to translate pictures of characters into a standard encoding scheme representing them, such as ASCII or Unicode. Consequently, by using OCR technology, the system in certain embodiments may convert scanned medical records, including typewritten and handwritten records, into machine-searchable text. By advantageously making use of OCR technology, certain embodiments described herein may search originally scanned sections of the EMR 151 for certain terms, as described below.

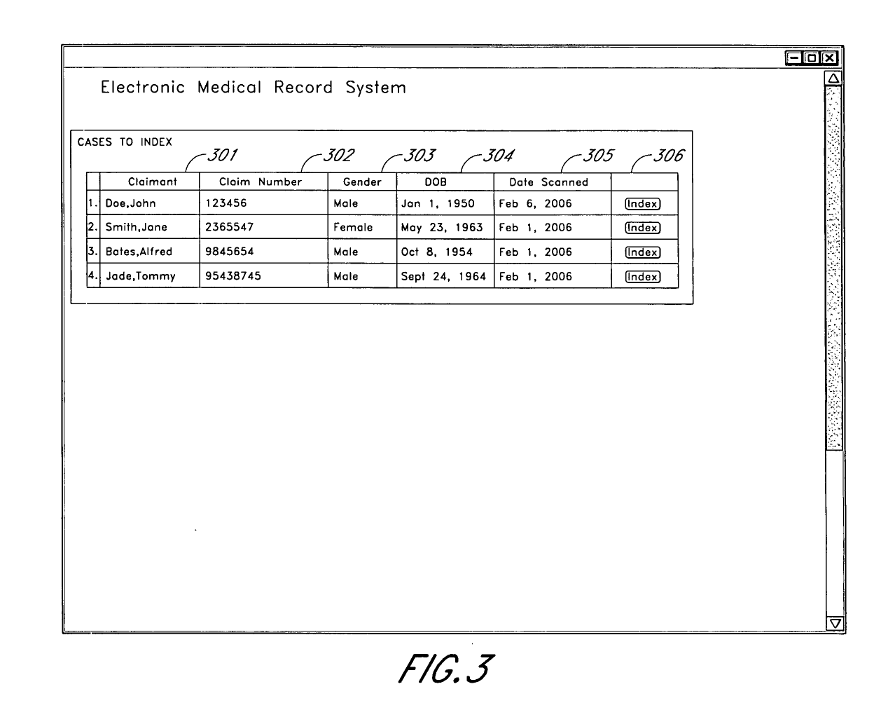

The electronic medical record system 100 in certain embodiments may contain an index section, wherein the contents of either the query display 110 or the EMR display 150 may be indexed by any known method in the art. FIG. 3 is a sample screen from a particular embodiment of the electronic medical record system 100 for disability claims showing an index feature. The electronic medical record system 100 may in the index list the patients whose data is stored in the system 301.) In certain embodiments of the electronic medical record system 100 configured for use with disability claims, the index may list a patient's disability claim number 302, gender 303, date of birth 304 and the date the EMR for the patient was scanned in 305. Furthermore, a user may then advantageously view data for a patient by selecting the patient from the index, for example, by pressing an “index” button 306. Although certain limited information was selected to be displayed in the index illustrated in FIG. 3, other information may be selected to be displayed in the index.

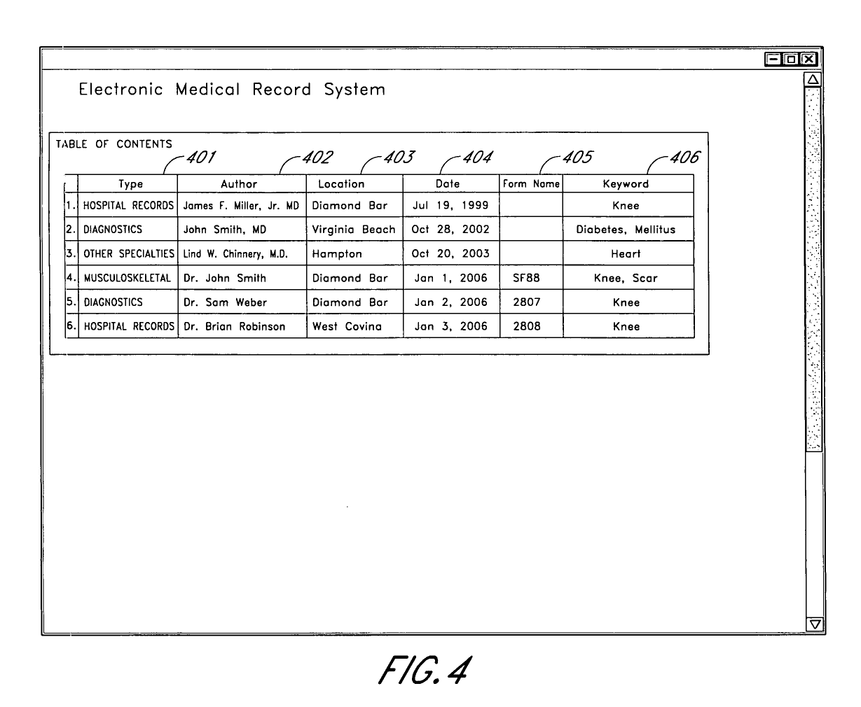

FIG. 4 is a sample screen from a particular embodiment of the electronic medical record system 100 showing a table of contents feature. Both the query display 110 and the EMR display 150 may in certain embodiments contain a table of contents or other section which identifies in brief the types of queries and medical history data made available to the system 100. In certain embodiments, the table of contents is an organized list of subjects which gives a summary of the content of the display. Table of contents may reference where each section starts. In certain embodiments, a user may click on a subject or record listed in the table of contents in order to view that subject or record. As shown in FIG. 4, the table of contents may list the records stored for a patient, including the type of record 401, the author of the record 402, the location the record was created 403, the date the record was created 404, the form it was created with 405, and keywords highlighted by the system in the record 406. In certain embodiments, if the EMR 151 contains data relevant to a portion of the table of contents, then the relevant portion of the table of contents may be highlighted or may otherwise identify that evidence of relevance to the aforementioned portion to the table of contents exists in the EMR 151. Alternatively, if there is no relevant portion in the EMR 151 responsive to a portion of the table of contents, then the aforementioned portion of the table of contents may similarly either not be highlighted or otherwise identify that relevant evidence to the portion of the table of contents does not exist in the EMR 151.

In certain embodiments, the system may contain searching capabilities. Wherein the data contained in the system 100 in both the EMR display 150 and the query display 110 both contain text, and not only scanned images, then the system may advantageously conduct a word search through the text according to methods known in the art in order to find words or characters. For example, if a user wanted to search both the EMR 151 and the medical queries 110 for the term “heart,” then the system would locate and display to the user instances of the word “heart” in both the EMR and the medical queries.

The data stored in the system 100, including the EMR 151 and the medical queries 111, may be secured in order to protect a patient's private information. By securing and restricting access to the data, security requirements such as the Health Insurance Portability and Accountability Act (“HIPAA”) may be met.

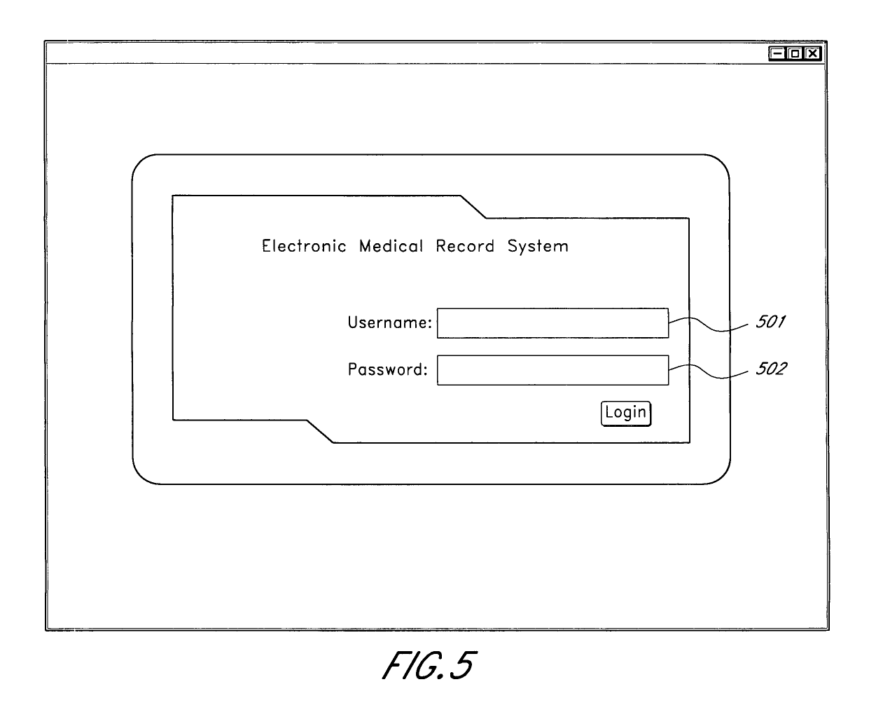

In certain embodiments, data may be secured by requiring a user to enter a password in order to access data stored on the system 100. FIG. 5 is a sample screen from a particular embodiment of the electronic medical record system 100 showing a sample login screen to protect access to medical record data. A login screen may require an authorized username 501 and password 502 in order to gain access to the system. By requiring a user to enter an authorized username and password, the system 100 advantageously increases the likelihood that only authorized users will have access to medical data stored in the system 100. For example, if the system 100 is meant to be used only by an authorized disability ratings specialist, then the specialist may configure the system to only grant access when a unique password is entered. Consequently, if the specialist keeps the unique password a secret, then only the specialist, an authorized user, will have access to the data. Other identification methods may also be used, including but not limited to fingerprint identification and voice identification.

In certain embodiments, a patient's entire EMR may advantageously be printed. This feature allows an authorized user to have a hard copy version of a patient's EMR whenever desired. By allowing a user to print out an entire EMR at one time instead of having to locate, request and receive sections of the medical record stored in a multitude of different locations, a user's access and efficiency to the EMR will be enhanced by a reducing the time it takes to gain access to a hardcopy of the EMR.

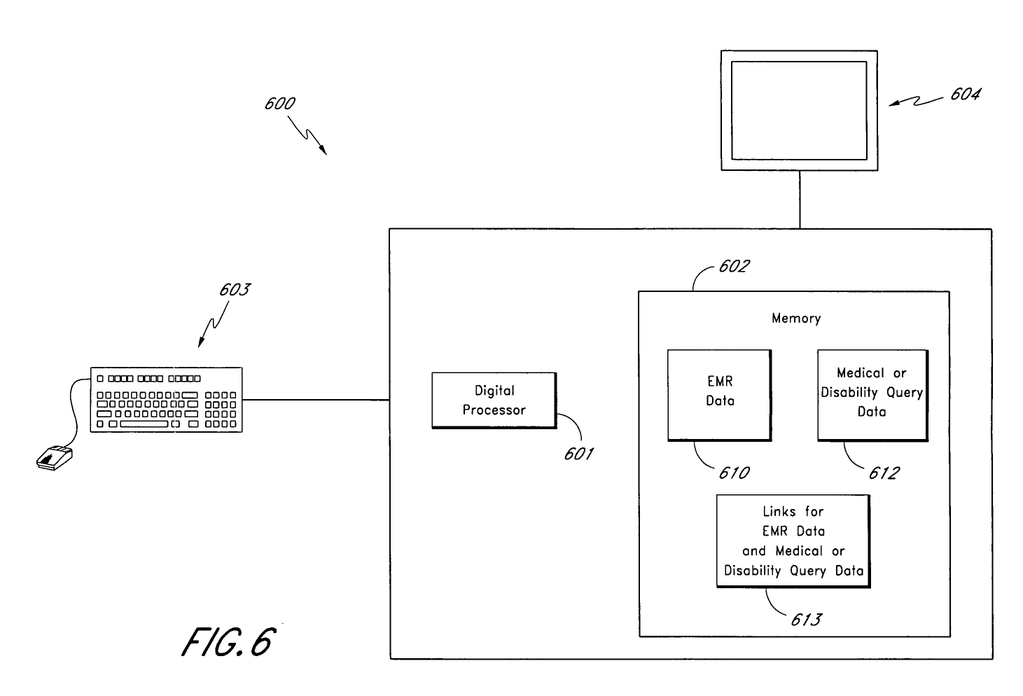

FIG. 6 shows a sample digital computer system 600 for use with the electronic medical record system 100. A sample electronic medical record system 100 in accordance with embodiments discussed herein includes a digital processor 601, memory 602, an input device 603, such as a keyboard or mouse, and an output display device 604 such as a computer monitor. The processor 601, such as a central processing unit (“CPU”) is responsible for providing the digital processing for the electronic medical record system 100. The computer system 600 also includes memory 602, such as memory storage devices, in order to store medical record data, such as EMR data 610, medical and disability query data 612, and the links between the EMR data and medical and disability query data 613. Memory may include RAM, ROM, hard disk memory, optical disk memory, and any other kind of storage memory.

Input devices 603 such as a keyboard and mouse may be used to input information to the computer system to control a cursor or other kind of pointer on the display, as discussed above. In addition to input devices, an output device such as a monitor 604 may be used to display images from the computer system. The monitor may be the primary means with which to display the query display 110 and the EMR display 150, also as discussed above.

While certain embodiments of the inventions have been described, these embodiments have been presented by way of example only, and are not intended to limit the scope of the inventions. Indeed, the novel methods and systems described herein may be embodied in a variety of other forms. Furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

1. An electronic medical record system comprising:
a medical query generated based on a medical or disability rules collection and based on an individual's medical or disability claim;
an electronic medical record module configured to access an electronic medical record containing data responsive to said query;
a viewing module configured for displaying at an output device at least a portion of said medical query and a portion of said electronic medical record; and
a linking module for linking at least a portion of said medical query to at least one section of said responsive data in said electronic medical record.

2. The system of claim 1, further comprising:
a retrieval module configured for retrieving said linked responsive data in said electronic medical record to said linked query in response to a retrieval request by a user of the viewer.

3. The system of claim 1, further comprising a highlighting module configured to highlight the at least one section of said responsive data in said electronic medical record.

4. The system of claim 1, further comprising an index feature configured to index at least a portion of said electronic medical record.

5. The system of claim 1, further comprising a search module configured to search through at least a portion of the electronic medical record In response to a search request by a user of the viewer.

6. The system of claim 1, further comprising a login sequence to enable only authorized users to access said electronic medical record.

7. A method of simultaneously viewing an electronic medical record and medical query, the method comprising:
enabling a display of a medical or disability query generated based on a medical or disability rules collection and based on an individual's medical or disability claim;
enabling a display of a portion of an electronic medical record containing data responsive to said query; and
enabling a user to electronically link at least a portion of said query to at least one section of said responsive data in said electronic medical record.

8. The method of claim 7, further comprising:
enabling a display of said linked responsive data in said electronic medical record to said linked query in response to a retrieval request by a user of the viewer.

9. The method of claim 7, further comprising enabling a highlighting of the at least one selection of said responsive data in said electronic medical record.

10. The method of claim 7, further comprising enabling an electronic search through at least a portion of the electronic medical record in response to a search request by a user of the viewer.

11. The method of claim 7, further comprising securing access using a login sequence to enable only authorized users to access said electronic medical record.

12. An electronic medical record system comprising:
a medical query based on a medical or disability rules collection and based on an individual's medical or disability claim;
means for accessing an electronic medical record containing data responsive to said query;
means for displaying at an output device at least a portion of said medical query and portion of said electronic medical record; and
means for linking at least a portion of said medical query to at least one section of said responsive data in said electronic medical record.

13. A method of simultaneously viewing an electronic medical record and medical query, the method comprising:
viewing a medical or disability query generated based on a medical or disability rules collection and based on an individual's medical or disability claim;
viewing a portion of an electronic medical record containing data responsive to said query; and
electronically linking at least a portion of said query to at least one section of said responsive data in said electronic medical record.

14. The method of claim 13, further comprising:
displaying at an output device said linked responsive data in said electronic medical record to said linked query in response to a retrieval request by a user of the viewer.

15. The method of claim 13, further comprising highlighting the at least one section of said responsive data in said electronic medical record.

16. The method of claim 13, further comprising electronically searching through at least a portion of the electronic medical record in response to a search request by a user of the viewer.

17. The method of claim 13, further comprising securing access using a login sequence to enable only authorized users to access said electronic medical record.
